(19) United States
(12) Patent Application Publication
(10) Pub. No.: US 2026/0193916 A1
(43) Pub. Date: Jul. 9, 2026

(54) ADJUSTABLE GATE HINGE

(71) Applicant: L & R Industries, Inc, Cabool, MO (US)

(72) Inventor: Darren JONES, Cabool, MO (US)

(73) Assignee: L & R Industries, Inc, Cabool, MO (US)

(21) Appl. No.: 19/338,407

(22) Filed: Sep. 24, 2025

Related U.S. Application Data
(60) Provisional application No. 63/742,132, filed on Jan. 6, 2025.

(51) Int. Cl. E05D 7/04; E05D 3/02; E05D 5/02

(52) U.S. Cl. CPC E05D 7/04; E05D 3/02; E05D 5/0215

(57) ABSTRACT

An adjustable gate hinge includes a clamp and a slider portion. The clamp defines a clamp slot. The slider portion defines a slide slot. The slider portion is adjustably connected to the clamp via a fastener extending through the clamp slot and the slide slot.

### CROSS-REFERENCES TO RELATED APPLICATIONS

This application claims priority to U.S. Provisional Ser. No. 63/742,132 , filed Jan. 6, 2025, the entire contents of which are incorporated herein by reference.

### TECHNOLOGY FIELD

The present disclosure generally relates to doors, gateways, and moveable barriers. More particularly, the exemplary embodiment of the present disclosure relates to an adjustable gate hinge for use with such doors, gateways, and moveable barriers.

### BACKGROUND

Gateways often include a gate pivotably mounted to a post or frame via hinges. Traditionally, the hinges are fixedly mounted to the gate and to the post. Thus, a pivot axis of the gate is fixedly aligned with the post, making the gate dependent on the post being plum or otherwise properly aligned within a particular setting. Further, even if the post is plum and/or correctly aligned, fixed hinges foreclose adjustment of the pivot axis to align the gate with uneven terrain, make the gate swing in a desired direction (e.g., open or close) via gravity, compensate for weight (e.g., hardware, locks, signage) added to the gate, etc. Additionally, over time and following repeated use, fasteners that fixedly attach the hinges to the gate and the post often loosen, causing the gate to sag. Therefore, the art recognizes a need for improved and more versatile gate hinges.

### SUMMARY

The present disclosure is directed to an adjustable gate hinge for use with doors, gateways, and moveable barriers. The adjustable gate hinge is particularly useful for gateways and gates for ranches and farms, but is not limited to such uses.

The present disclosure provides an improved pivoting connection between a post and a gate, particularly those used in agricultural settings, via a plurality of adjustable hinge assemblies. Each adjustable hinge assembly includes a clamping portion configured to grasp the post and a slider portion adjustably connected to the clamping portion and configured to pivotably connect to the gate. By adjusting the slider portions relative to the clamping portions, a pivot axis of the gate may be repositioned relative to the post.

Some embodiments provide an adjustable gate hinge that includes a clamp and a slider portion. The clamp defines a clamp slot. The slider portion defines a slide slot. The slider portion is adjustably connected to the clamp via a fastener extending through the clamp slot and the slide slot.

In some embodiments, the slider portion is translatably and rotatably adjustable relative to the clamp.

In some embodiments, the clamp is a first clamp, the fastener is a first fastener, a second clamp is adjustably connected to the first clamp via a second fastener, and the first clamp approaches the second clamp when the second fastener is tightened.

In some embodiments, a clamping nut is disposed between an upper clamp plate and a lower clamp plate of the first clamp, and the second fastener threadably engages the clamping nut.

In some embodiments, the clamping nut is non-circular and engages at least one of the upper clamp plate and the lower clamp plate.

In some embodiments, the upper clamp plate and the lower clamp plate extend from a fastener plate, and the clamping nut abuts the fastener plate.

In some embodiments, one or more of the clamp slot and the slide slot delimit rotation of the slider portion relative to the clamp.

In some embodiments, the clamp slot and the slide slot are diagonal relative to one another.

In some embodiments, the clamp slot is a first clamp slot, the slide slot is a first slide slot, the fastener is a first fastener, and the slider portion is adjustably connected to the clamp via a second fastener extending through the second clamp slot and the second slide slot.

In some embodiments, the first clamp slot is orthogonal to the second clamp slot, and the first slide slot is colinear with the second slide slot.

In some embodiments, the clamp is arcuate.

In some embodiments, the clamp defines a notch.

In some embodiments, the notch is at least partially serrated.

In some embodiments, a hinge pin extends through the slider portion.

In some embodiments, the slider portion is an upper slider portion, a lower slider portion defines a second slide slot, the fastener is a first fastener, and the lower slider portion is adjustably connected to the clamp via a second fastener extending through the clamp slot and the lower slide slot.

Some embodiments provide an adjustable gate hinge kit that includes a post mount and a swing portion. The post mount is configured to removably mount to a post. The swing portion is pivotably connected to the post mount and is configured to removably mount to a gate. The post mount defines a pivot axis for the gate relative to the post and permits adjustment of the pivot axis relative to the post. The swing portion is configured to be non-rotatable relative to the gate.

In some embodiments, the post mount includes a slider portion translatably and rotatably connected to a clamping portion.

In some embodiments, the swing portion includes an anti-rotation buckle configured to prevent rotation of a pivot strap about an upright of the gate.

Some embodiments provide a swing portion of a hinge. The swing portion includes a pivot strap, an anti-rotation buckle, and a fastener. The pivot strap is configured to at least partially wrap around an upright of a gate. The anti-rotation buckle is configured to engage the pivot strap and at least partially wrap around a crossbar of the gate. The fastener extends through the pivot strap and the anti-rotation buckle.

In some embodiments, the pivot strap extends between a first fastener lobe and a second fastener lobe of the anti-rotation buckle.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is an isometric view of an adjustable gate hinge kit installed on a gateway, according to an embodiment;

FIG. 2 is a first isometric view of an adjustable hinge assembly of the adjustable gate hinge kit of FIG. 1 installed on the gateway of FIG. 1;

FIG. 3 is a second isometric view of the adjustable hinge assembly of FIG. 2 installed on the gateway of FIG. 1;

FIG. 4 is an isometric view of a chain hook assembly of the adjustable gate hinge kit of FIG. 1 installed on the gateway of FIG. 1;

FIG. 5 is an isometric view an anti-drift drop rod assembly of the adjustable gate hinge kit of FIG. 1 installed on the gateway of FIG. 1 and in a deployed configuration;

FIG. 6 is an isometric view of a post mount of the adjustable hinge assembly of FIG. 2;

FIG. 7 is an exploded view of the post mount of FIG. 6;

FIG. 8 is an isometric view of an anti-rotation buckle of the adjustable hinge assembly of FIG. 2;

FIG. 9 is an exploded view of the anti-rotation buckle of FIG. 8;

FIG. 10 is an isometric view of a hook buckle of the chain hook assembly of FIG. 4;

FIG. 11 is an exploded view of the hook buckle of FIG. 10;

FIG. 12 is an isometric view of the anti-drift drop rod assembly of FIG. 5;

FIG. 13 is an isometric view of a mounting bracket, according to an embodiment;

FIG. 14 is an isometric view of an anti-drift drop rod, according to an embodiment;

FIG. 15 is an isometric view of an anti-drift drop rod, according to another embodiment; and

FIG. 16 is an isometric view of an anti-drift drop rod, according to a further embodiment.

### DETAILED DESCRIPTION

Various modifications to the illustrated embodiments will be readily apparent to those skilled in the art, and the generic principles herein can be applied to other embodiments and applications. Thus, it is to be understood that the disclosure is not limited in its application to the details of the configuration and arrangement of components set forth in the following description or illustrated in the accompanying drawings. The disclosure is capable of being practiced or of being carried out in various ways and is to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of the disclosure.

Before any embodiments are explained in detail, it is to be understood that the disclosure is not limited in its application to the details of construction and the arrangement of components set forth in the following description or illustrated in the attached drawings. The disclosure is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

As mentioned above, current devices and methods to mount gates to posts are inadequate and inefficient. Thus, it would be useful to provide more sophisticated and versatile devices and methods to pivotably connect moveable barriers to stationary structures.

In overview of the present teaching, gateways often include a gate pivotably, swingably, and/or hingedly mounted to a post and/or frame. In some instances, particularly in agricultural settings, the post may not be exactly plum and/or the terrain surrounding the gate may be uneven. The present disclosure provides an adjustable gate hinge kit including an adjustable hinge assembly that facilitates horizontally, leveling the gate and/or adjusting the gate to have relatively consistent spacing with a ground surface. The adjustable gate hinge kit further includes a chain hook assembly and an anti-drift drop rod that aid in immobilizing the gate to a stationary object and/or the ground surface, respectively.

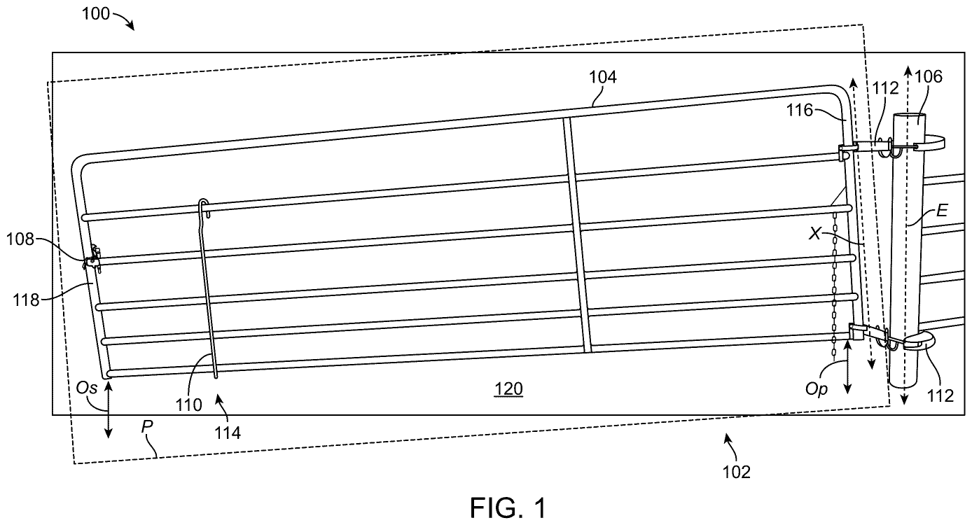

Referring generally to FIG. 1, an adjustable gate hinge kit 100 installed on a gateway 102, which includes a gate 104 and a post 106, is illustrated. The adjustable gate hinge kit 100 includes a chain hook assembly 108, an anti-drift drop rod assembly 110, and a plurality of adjustable hinge assemblies 112 mounted to the gate 104. The gate 104 is moveably connected the post 106 via the plurality of adjustable hinge assemblies 112. Additionally, the anti-drift drop rod assembly 110 is shown in a stowed configuration 114. The gate 104 has a post end 116 and a swing end 118, which define a post end offset Op and a swing end offset Os relative to a ground surface 120, respectively.

Remaining with FIG. 1, the post end 116 of the gate 104 is pivotably, translatably, and rotatably connected to the post 106 via the plurality of adjustable hinge assemblies 112. More specifically, the gate 104 defines a plane P, which is substantially vertical, and the plurality of adjustable hinge assemblies 112 define a pivot axis X. The pivot axis X is located within the plane P and is adjustable relative to a post axis E via the plurality of adjustable hinge assemblies 112. Consequently, the gate 104 pivots and/or swings substantially horizontally relative to the post 106 about the pivot axis X. Further, the gate 104 adjustably rotates and translates relative to the post 106 within the plane P via the plurality of adjustable hinge assemblies 112. Thus, the plurality of adjustable hinge assemblies 112 permit the gate 104 to be adjusted such that the post end offset Op is substantially equal to the swing end offset Os, the pivot axis X is plum with the ground surface 120, the pivot axis X is parallel to the post axis E, and/or any position therebetween within the plane P.

With reference to FIG. 1, it should be appreciated that the gate 104 may be adjusted and/or repositioned relative to the post 106 via the adjustable hinge assemblies 112 to align with the ground surface 120, swing in a desired direction (e.g., open or close) via gravity, and/or correct unwanted sagging of the gate 104 relative to the post 106. It should additionally be appreciated that the adjustable hinge assemblies 112 permit repeated and/or temporary repositioning of the gate 104 relative to the post 106.

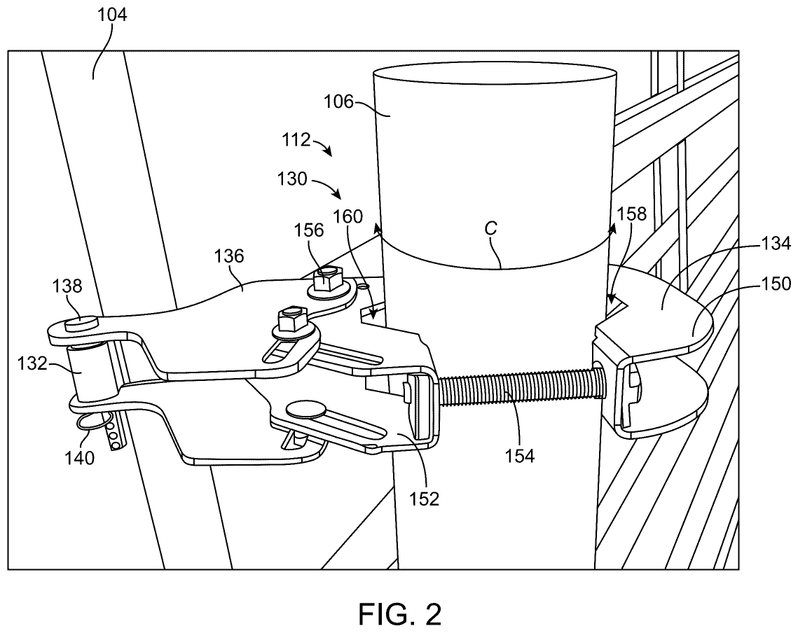

Turning to FIG. 2, each adjustable hinge assembly 112 includes a post mount 130 pivotably connected to a swing portion 132. The post mount 130 and the swing portion 132 are configured to connect to the post 106 and to the gate 104, respectively. The post mount 130 includes a clamping portion 134 slidably, translatably, and pivotably connected to a slider portion 136. A hinge pin 138 extends through and pivotably connects the swing portion 132 to the slider portion 136. In some instances, a retainer 140 secures the hinge pin 138 in the slider portion 136. Thus, by removing the retainer 140 and the hinge pin 138, the gate 104 may be easily disconnected from the post 106. It should be understood that, although the hinge pin 138 is depicted as a smooth shaft with a flanged head in the illustrated example of FIG. 2, the hinge pin 138 may be any type of pivoting axle (e.g., a bolt and nut, interlocking hinge fingers, a ball and socket, etc.). Although the retainer 140 is depicted as a cotter pin in FIG. 2, the retainer 140 may be any type of device suitable to secure the hinge pin 138 in the slider portion 136 (e.g., nut and bolt, retaining ring, clamp, etc.).

Remaining with FIG. 2, the clamping portion 134 includes a first clamp 150 adjustably secured to a second clamp 152 via a plurality of clamp fasteners 154, which, in some instances, are threaded. Similarly, the slider portion 136 is slidably, translatably, and pivotably connected to the second clamp 152 via a plurality of slide fasteners 156, which, in some instances, are threaded. The first clamp 150 and the second clamp 152 respectively define a first post notch 158 and a second post notch 160, which are each configured to receive a portion of a circumference C of the post 106. Thus, the first clamp 150 and/or the second clamp 152 may be arcuate, arched, bridge-shaped, etc. It should be understood that when the first clamp 150 and the second clamp 152 are loosened, the adjustable hinge assembly 112 may be slid along and rotated about the post 106 to any axial and circumferential position along the post 106. Thus, multiple pairs of adjustable hinge assemblies 112 may be used to hang multiple gates from the post 106. Additionally, two first clamps 150 may be used on both sides of the post 106 for hanging two gates 104 on the same post 106. It should be understood that that the first clamp 150 and/or the second clamp 152 may be sized to accommodate any size post 106.

Remaining with FIG. 2, more specifically, when the clamp fasteners 154 are tightened, the first clamp 150 and the second clamp 152 approach one another to partially wrap around and tighten against the post 106. With the clamping portion 134 tightly secured about the post 106, the slider portion 136 may be moved relative to the clamping portion 134 to adjust the gate 104 relative to the post 106. Conversely, when the clamp fasteners 154 are loosened, the first clamp 150 and the second clamp 152 are distanced from one another. Thus, the post mount 130 may be adjusted along and/or selectively removed from the post 106.

Looking to FIGS. 1 and 2, more specifically, when the slide fasteners 156 of both adjustable hinge assemblies are tightened, the slider portions 136 are respectively fixed to the second clamp 152, which fixes the pivot axis X relative to the post 106. Conversely, the slide fasteners 156 may be easily loosened to reposition the slider portions 136 along the second clamps 152, which readjusts the pivot axis X relative to the post 106.

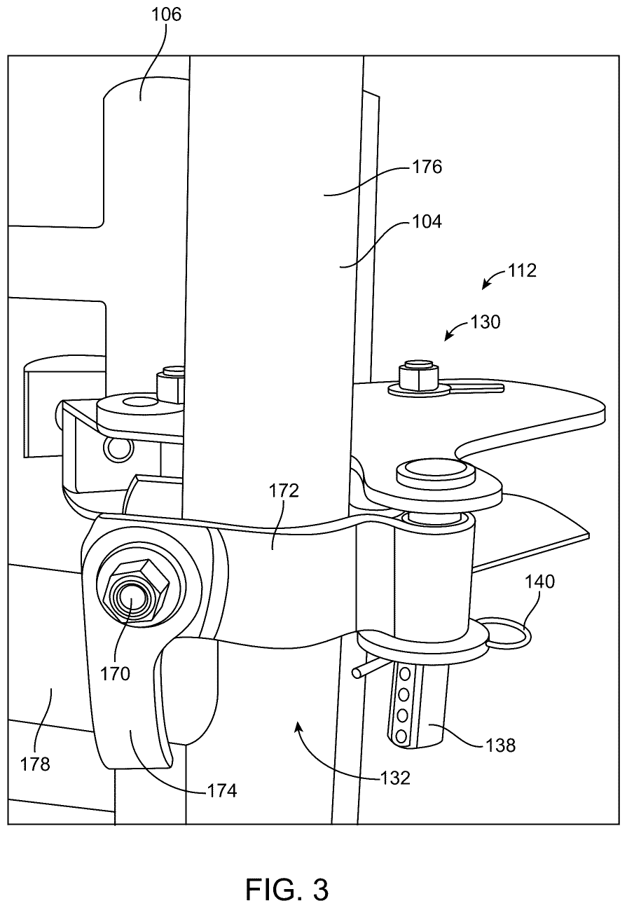

With reference to FIG. 3, the swing portion 132 includes an anti-rotation fastener 170 engaging and/or extending through a pivot strap 172 and an anti-rotation buckle 174. The pivot strap 172 receives and partially wraps around a first upright 176 of the gate 104. Further, the hinge pin 138 rotatably extends through the pivot strap 172. The anti-rotation buckle 174 receives and partially wraps around a first crossbar 178 of the gate 104 to connect to the pivot strap 172 via the anti-rotation fastener 170, which, in some instances, is threaded. Thus, the anti-rotation buckle 174 prevents the pivot strap 172 from freely rotating about the first upright 176.

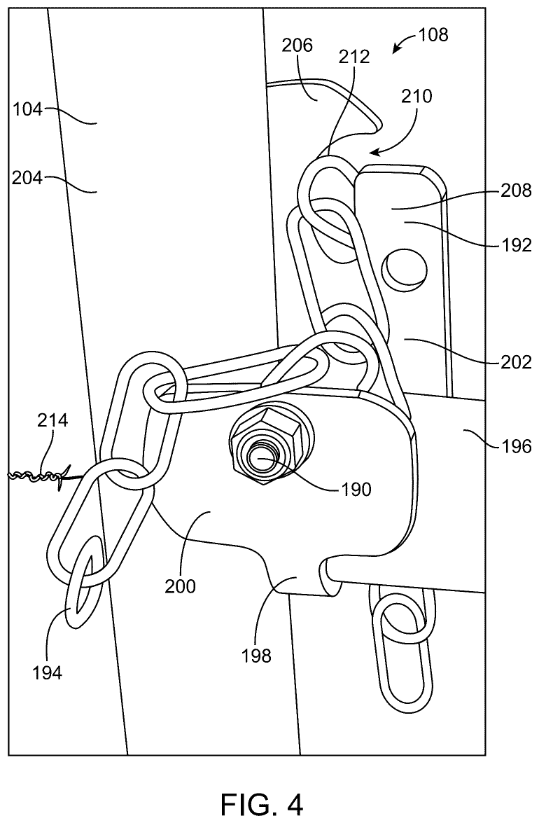

With reference to FIG. 4, the chain hook assembly 108 includes a hook fastener 190 extending through a hook buckle 192 and a chain 194. The hook buckle 192 receives and partially wraps around a second crossbar 196 of the gate 104. The hook buckle 192 includes a strap 198 connected to an anti-rotation lobe 200 and a hook lobe 202. When the hook fastener 190 is tightened, a second upright 204 of the gate 104 is compressed between the anti-rotation lobe 200 and the hook lobe 202. Thus, the anti-rotation lobe 200 and the hook lobe 202 prevent the hook buckle 192 from freely rotating about the second crossbar 196. Further, the hook lobe 202 includes a hook 206 and an upwardly extending tab 208 that define a hook slot 210. The hook slot 210 is configured to receive one or more links 212 of the chain 194 and, in some instances, is at least partially arcuate. The chain 194 may be wrapped around a stationary object 214 (depicted as wire or post or any fencing object) and hooked onto the hook 206 to secure the gate 104 to the stationary object 214. It should be understood that, although the stationary object 214 is depicted as wire fencing in the illustrated example of FIG. 4, the gate 104 may be conveniently secured to any stationary object 214 around which the chain 194 may be wrapped (e.g., a post, a picket, a tree, etc.).

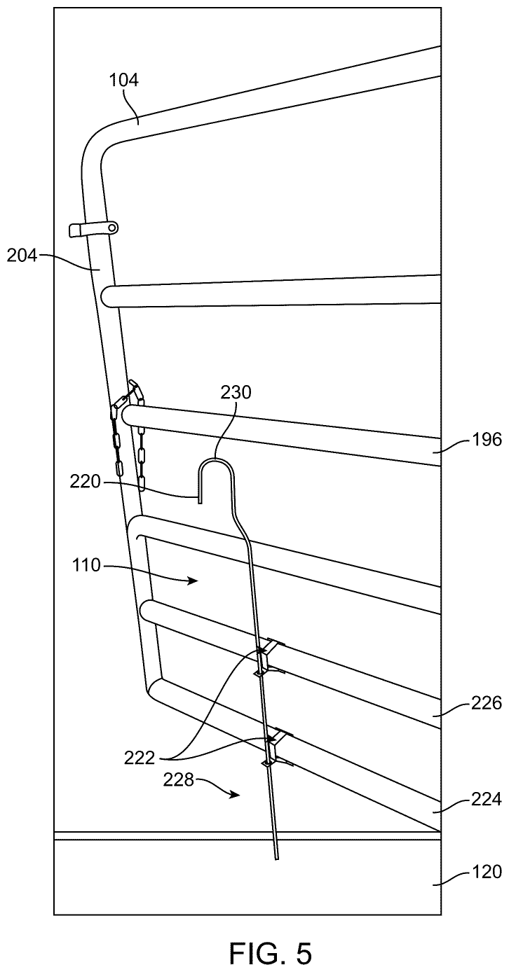

With reference to FIG. 5, the anti-drift drop rod assembly 110 includes a drop rod 220 slidably and rotatably extending through a plurality of mounting brackets 222, which are respectively attached to a third crossbar 224 and a fourth crossbar 226 of the gate 104. Thus, the drop rod 220 is slidably and rotatably mounted to the gate 104. The drop rod 220 is shown in a deployed configuration 228 in which the drop rod 220 contacts the ground surface 120 to prevent the gate 104 from pivoting relative to the post 106 (shown in FIG. 1). The drop rod 220 includes a storage hook 230 configured to hook onto the second crossbar 196 in the stowed configuration 114 (shown in FIG. 1). Thus, the gate 104 may be conveniently immobilized at any position along its swing via the drop rod 220.

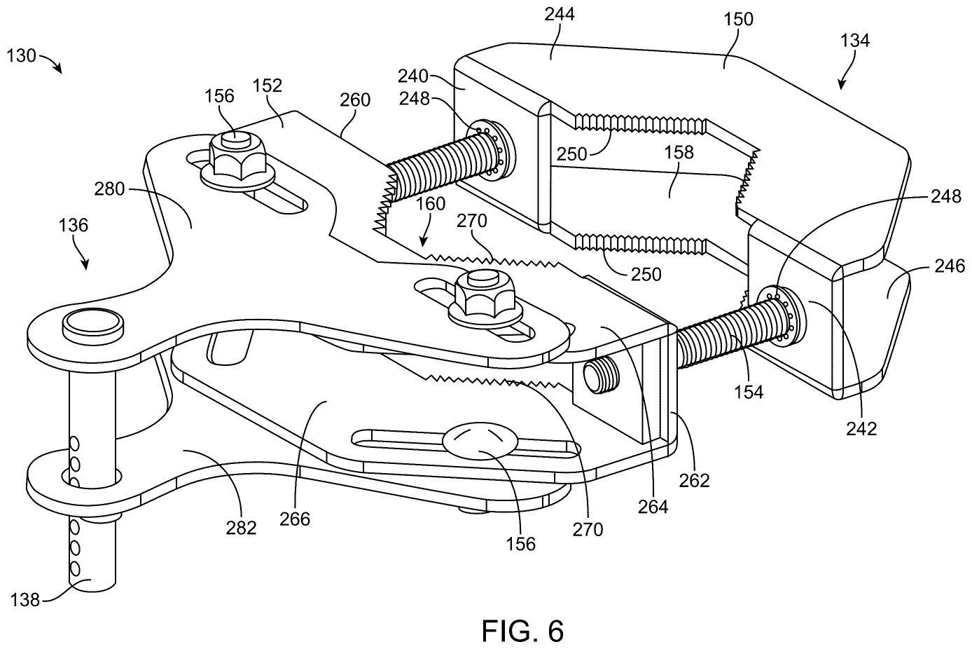

With reference to FIG. 6, more specifically, the first clamp 150 includes a first fastener plate 240 and a second fastener plate 242 connected to a first upper clamp plate 244 and a first lower clamp plate 246. The clamp fasteners 154 extend through the first fastener plate 240 and the second fastener plate 242. In some instances, inwardly toothed, flexible, and/or elastomeric washers 248 secure the clamp fasteners 154 in the first fastener plate 240 and in the second fastener plate 242. Further, in some instances, the first upper clamp plate 244 and the first lower clamp plate 246 include serrations 250 and/or rubberized portions (not shown) at least partially defining the first post notch 158 and configured to grip and/or dig into the post 106 (shown in FIG. 1).

Remaining with FIG. 6, similarly, the second clamp 152 includes a third fastener plate 260 and a fourth fastener plate 262 connected to a second upper clamp plate 264 and a second lower clamp plate 266. The clamp fasteners 154 extend through the third fastener plate 260 and the fourth fastener plate 262. Further, in some instances, the second upper clamp plate 264 and the second lower clamp plate 266 include serrations 270 at least partially defining the second post notch 160 and configured to grip and/or dig into the post 106 (shown in FIG. 1).

Referring again to FIG. 6, the slider portion 136 includes an upper slider 280 and a lower slider 282 slidably, translatably, and limitedly rotatably connected to the second upper clamp plate 264 and the second lower clamp plate 266, respectively, via the slide fasteners 156.

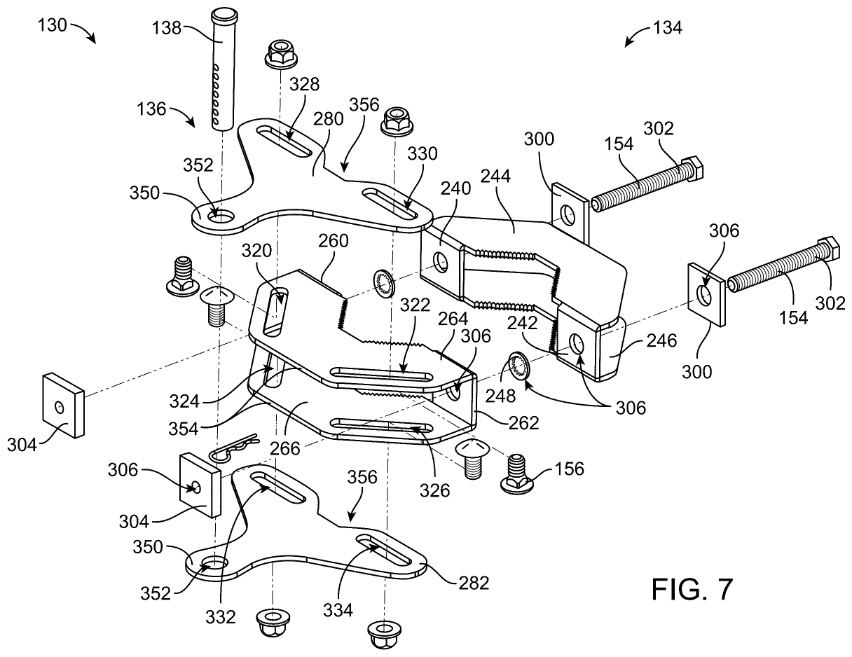

Turning to FIG. 7, more specifically, the post mount 130 further includes a plurality of washers 300 respectively abutting the first fastener plate 240 and the second fastener plate 242 between the first upper clamp plate 244 and the first lower clamp plate 246. In some instances, the washers 300 are rectilinear (e.g., rectangular, square, etc.). Further, each clamp fastener 154 includes a clamping bolt 302 threadably engageable with a clamping nut 304. The clamping nuts 304 respectively abut the third fastener plate 260 and the fourth fastener plate 262 between the second upper clamp plate 264 and the second lower clamp plate 266. The clamping bolts 302 extend through a plurality of openings 306 defined in the fastener plates 240, 242, 260, 262, the washers 248, 300, and the clamping nuts 304.

Remaining with FIG. 7, in some instances, the clamping nuts 304 are non-circular (e.g., rectilinear, square, polygonal, ellipsoid, ovate, etc.), sized, and configured to contact the second upper clamp plate 264 and the second lower clamp plate 266. In some instances, where the clamping nuts 304 are circular, a circumference of the clamping nut 304 is non-concentric with the clamping bolt 302. Thus, when the clamping bolts 302 are turned in the clamping nuts 304, the second upper clamp plate 264 and/or the second lower clamp plate 266 provide reaction forces to the clamping nuts 304. Consequently, the clamping bolts 302 threadably advance and retreat in the clamping nuts 304 to respectively approach and distance the first clamp 150 and the second clamp 152. Accordingly, turning the clamping bolts 302 in the clamping nuts 304 selectively tightens and loosens the post mount 130 about the post 106 (shown in FIG. 1).

Referring again to FIG. 7, the second upper clamp plate 264 defines a first upper clamp slot 320 and a second upper clamp slot 322. Similarly, the second lower clamp plate 266 defines a first lower clamp slot 324 and a second lower clamp slot 326. The first upper clamp slot 320 is aligned with the first lower clamp slot 324. Likewise, the second upper clamp slot 322 is aligned with the second lower clamp slot 326. Further, the upper slider 280 defines a first upper slide slot 328 and a second upper slide slot 330. Similarly, the lower slider 282 defines a first lower slide slot 332 and a second lower slide slot 334. The slots 320-334 provide adjustability to the upper slider 280 and the lower slider 282 relative to the second upper clamp plate 264 and the second lower clamp plate 266.

Remaining with FIG. 7, one of the slide fasteners 156 extends through the first upper clamp slot 320 and the first upper slide slot 328. Similarly, one of the slide fasteners 156 extends through the second upper clamp slot 322 and the second upper slide slot 330. Thus, the first upper clamp slot 320 and the second upper clamp slot 322 intersect the first upper slide slot 328 and the second upper slide slot 330, respectively. In some instances, the first upper clamp slot 320 and the second upper clamp slot 322 are orthogonal to one another. Further, in some instances the first upper slide slot 328 and the second upper slide slot 330 are colinear with one another. Thus, in some instances, the first upper clamp slot 320 and the second upper clamp slot 322 are non-orthogonal, non-parallel, non-colinear, and/or diagonal relative to the first upper slide slot 328 and the second upper slide slot 330. Thus, the upper slider 280 is translatably, slidably, and limitedly rotatably connected to the second upper clamp plate 264.

Referring again to FIG. 7, one of the slide fasteners 156 extends through the first lower clamp slot 324 and the first lower slide slot 332. Similarly, one of the slide fasteners 156 extends through the second lower clamp slot 326 and the second lower slide slot 334. Thus, the first lower clamp slot 324 and the second lower clamp slot 326 intersect the first lower slide slot 332 and the second lower slide slot 334, respectively. In some instances, the first lower clamp slot 324 and the second lower clamp slot 326 are orthogonal to one another. Further, in some instances, the first lower slide slot 332 and the second lower slide slot 334 are colinear with one another. Thus, in some instances, the first lower clamp slot 324 and the second lower clamp slot 326 are non-orthogonal, non-parallel, non-colinear, and/or diagonal relative to the first lower slide slot 332 and the second lower slide slot 334. Thus, the lower slider 282 is translatably, slidably, and limitedly rotatably connected to the second lower clamp plate 266.

With reference to FIG. 7, additionally, the upper slider 280 and the lower slider 282 each include a pivot lobe 350, through which the hinge pin 138 extends via a pin opening 352. In operation, the slide fasteners 156 may be tightened and loosened to selectively reposition and fix the upper slider 280 and the lower slider 282 relative to the second clamp 152, via the slots 320-334. Thus, the gate 104 may be adjusted relative to the post 106 (shown in FIG. 1) via the slide fasteners 156 sliding in the slots 320-334. In some instances, an outer edge 354 of the second upper clamp plate 264 and/or the second lower clamp plate 266 visible through notches 356 defined in the upper slider 280 and the lower slider 282 may indicate a maximum adjustment travel of the gate 104 relative to the post 106 (shown in FIG. 1).

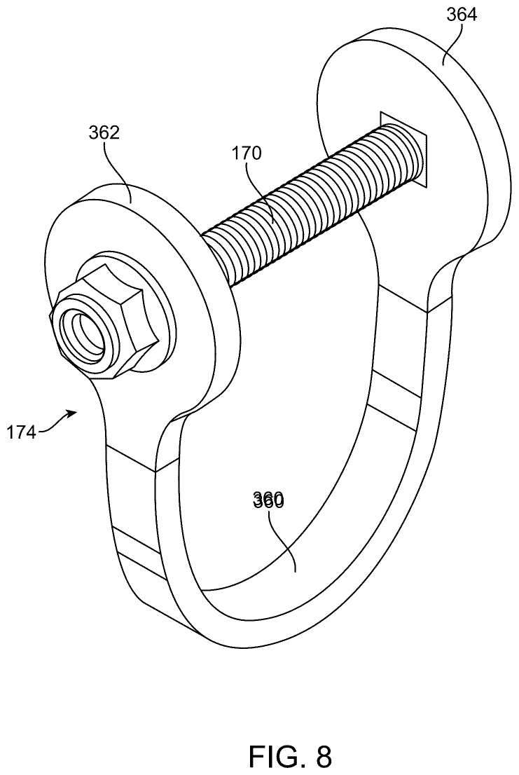

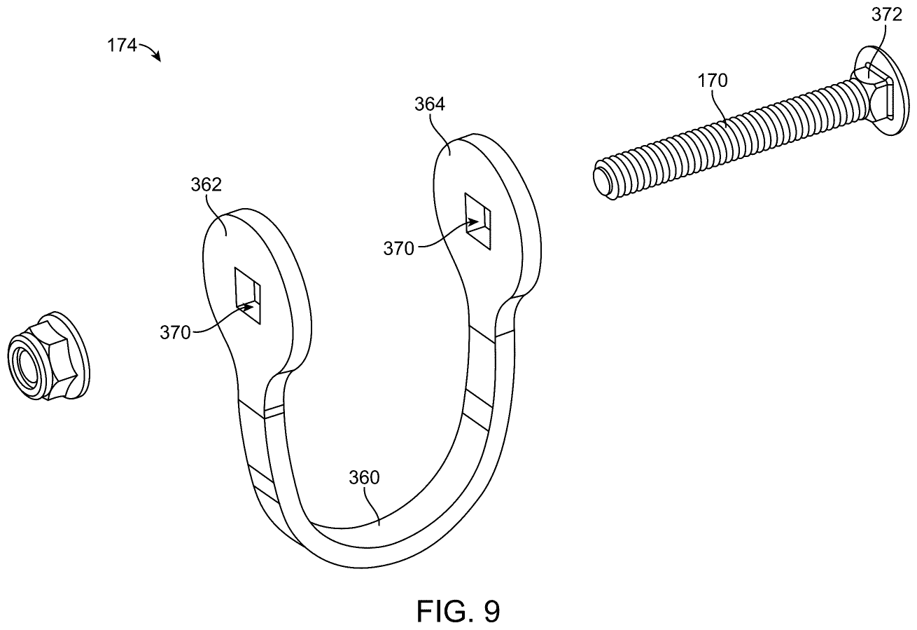

Turning to FIGS. 8 and 9, the anti-rotation buckle 174 includes a strap 360 connected to a first fastener lobe 362 and a second fastener lobe 364. The anti-rotation fastener 170 extends through the first fastener lobe 362 and the second fastener lobe 364. In some instances, the anti-rotation fastener 170 is threaded.

Referring to FIG. 9, the first fastener lobe 362 and the second fastener lobe 364 each define an opening 370 through which the anti-rotation fastener 170 extends. In some instances, one or more of the openings 370 is non-circular and thus matingly receives a correspondingly non-circular portion 372 of the anti-rotation fastener 170. Thus, the anti-rotation buckle 174 engages and provides reaction forces to the anti-rotation fastener 170 when the anti-rotation fastener 170 is tightened or loosened.

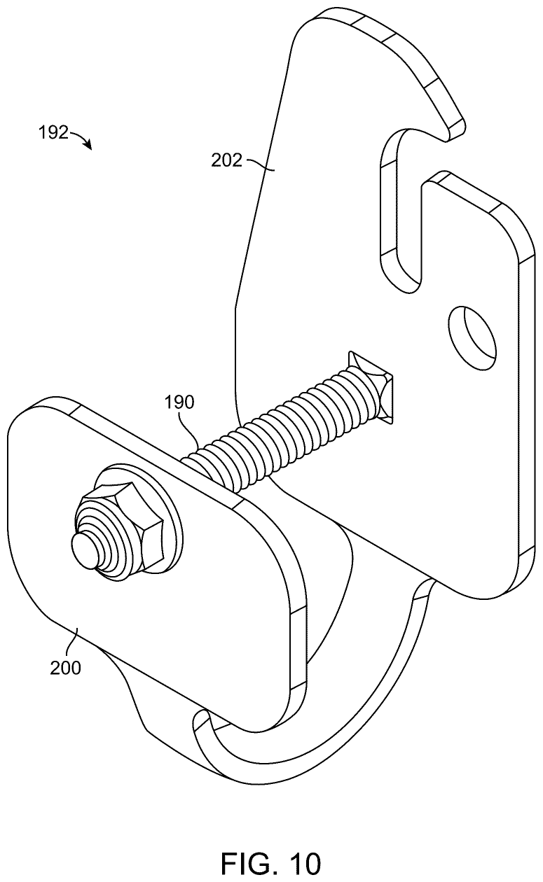

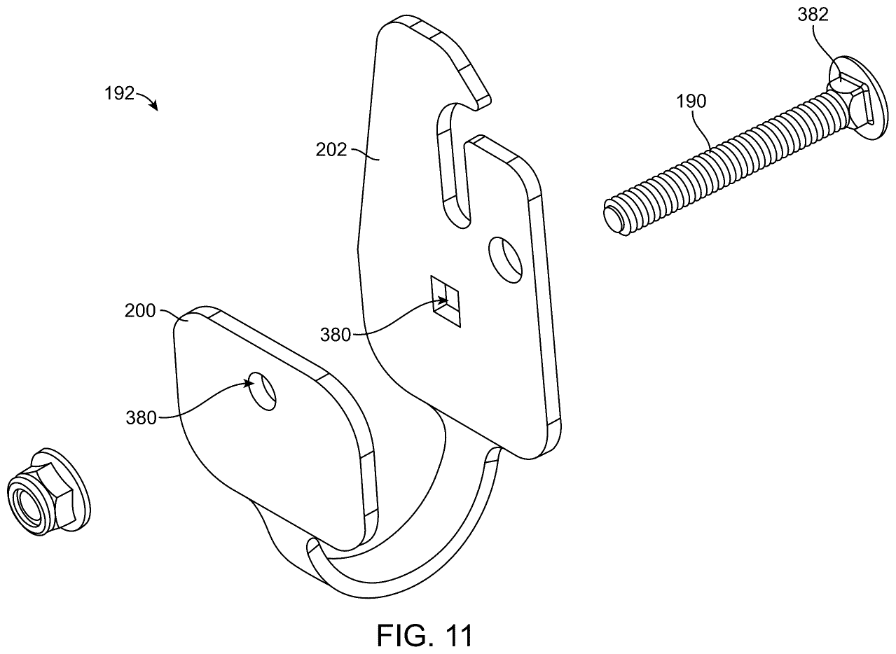

With reference to FIGS. 10 and 11, the hook fastener 190 extends through the anti-rotation lobe 200 and the hook lobe 202 of the hook buckle 192. In some instances, the hook fastener 190 is threaded.

Referring to FIG. 11, the anti-rotation lobe 200 and the hook lobe 202 each define an opening 380 through which the hook fastener 190 extends. In some instances, one or more of the openings 380 is non-circular and thus matingly receives a correspondingly non-circular portion 382 of the hook fastener 190. Thus, the hook buckle 192 engages and provides reaction forces to the hook fastener 190 when the hook fastener 190 is tightened or loosened.

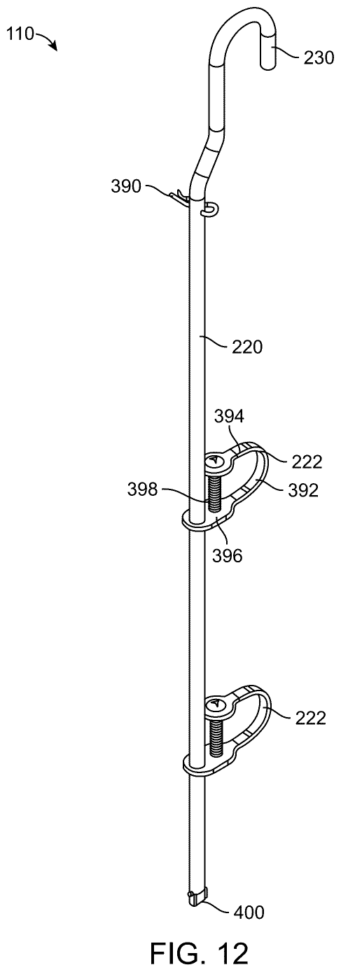

With reference to FIG. 12, the anti-drift drop rod assembly 110 further includes a cotter pin 390 extending through the drop rod 220. Further, each mounting bracket 222 includes a strap 392 connected to an upper lobe 394 and a lower lobe 396. A mounting fastener 398 extends through the upper lobe 394 and the lower lobe 396. The drop rod 220 slidably and rotatably extends through the lower lobes 396, which are longer than the upper lobes 394. A flattened tip 400 and the cotter pin 390 secure the drop rod 220 in and delimit sliding movement relative to the mounting brackets 222.

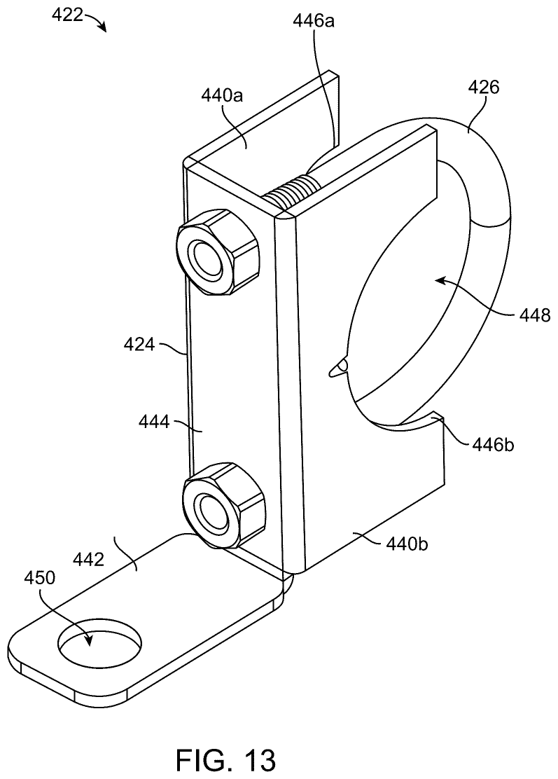

FIG. 13 illustrates a mounting bracket 422 according to an embodiment. The mounting bracket 422 is useable with the drop rod 220 of FIG. 12 alternatively or in addition to the mounting bracket 222 of FIG. 12. The mounting bracket 422 includes a housing 424 and a clamping fastener 426 (e.g., a U-bolt), which, in some instances, is threaded.

The housing 424 includes a first clamping wing 440a, a second clamping wing 440b, and a carrier tab 442 extending from a support strip 444. The first and second clamping wings 440a, b have first and second arcuate edges 446a, b, respectively. The first and second arcuate edges 446a, b and the clamping fastener 426 define an opening 448, which, in some instances is rounded (e.g., circular, elliptical, ovoid, etc.). The carrier tab 442 defines an opening 450 configured to receive, for example, the drop rod 220 of FIG. 12.

In operation, the housing 424 and the clamping fastener 426 are assembled and tightened about a structure (e.g., the first crossbar 178 of FIG. 3). Thus, the structure extends through the opening 448. Further, a rod (e.g., the drop rod 220 of FIG. 12) is slidably inserted through the opening 450.

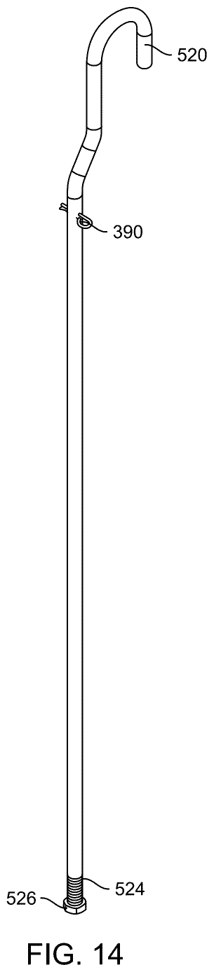

FIG. 14 illustrates a drop rod 520 according to an embodiment. The drop rod 520 is useable with the mounting bracket 222 of FIG. 12 and the mounting bracket 422 of FIG. 13. The cotter pin 390 extends through the drop rod 220, which is threaded at a lower end 524 and configured to threadably engage a nut 526. The cotter pin 390 and the nut 526 secure the drop rod 520 in and delimit sliding movement relative to the mounting brackets 222 (shown in FIG. 12) and/or the mounting brackets 422 (shown in FIG. 13).

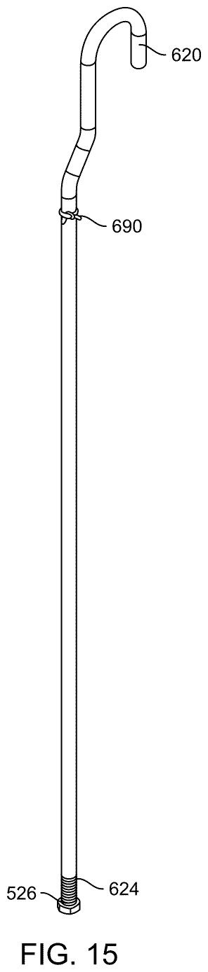

FIG. 15 illustrates a drop rod 620 according to an embodiment. The drop rod 620 is useable with the mounting bracket 222 of FIG. 12 and the mounting bracket 422 of FIG. 13. A hose clamp 690 is clamped about the drop rod 620, which is threaded at a lower end 624 and configured to threadably engage the nut 526. The hose clamp 690 and the nut 526 secure the drop rod 620 in and delimit sliding movement relative to the mounting brackets 222 (shown in FIG. 12) and/or the mounting brackets 422 (shown in FIG. 13).

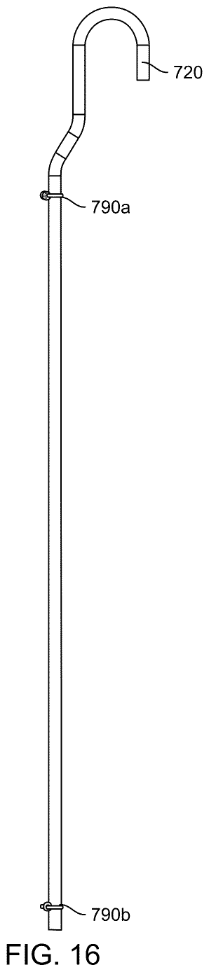

FIG. 16 illustrates a drop rod 720 according to an embodiment. The drop rod 720 is useable with the mounting bracket 222 of FIG. 12 and the mounting bracket 422 of FIG. 13. A first hose clamp 790a and a second hose clamp 790b are clamped about the drop rod 720. The first and second hose clamps 790a, b secure the drop rod 720 in and delimit sliding movement relative to the mounting brackets 222 (shown in FIG. 12) and/or the mounting brackets 422 (shown in FIG. 13).

In other embodiments, other configurations are possible. For example, those of skill in the art will recognize, according to the principles and concepts disclosed herein, that various combinations, sub-combinations, and substitutions of the components discussed above can provide improved gate hinges.

The above description of the disclosed exemplary embodiments is provided to enable any person skilled in the art to make or use one or more aspects of the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. An adjustable gate hinge comprising:
a clamp defining a clamp slot; and
a slider portion defining a slide slot, the slider portion being adjustably connected to the clamp via a fastener extending through the clamp slot and the slide slot.

2. The adjustable gate hinge of claim 1, wherein the slider portion is translatably and rotatably adjustable relative to the clamp.

3. The adjustable gate hinge of claim 1, wherein
the clamp is a first clamp,
the fastener is a first fastener,
a second clamp is adjustably connected to the first clamp via a second fastener, and
the first clamp approaches the second clamp when the second fastener is tightened.

4. The adjustable gate hinge of claim 3, wherein
a clamping nut is disposed between an upper clamp plate and a lower clamp plate of the first clamp, and
the second fastener threadably engages the clamping nut.

5. The adjustable gate hinge of claim 4, wherein the clamping nut is non-circular and engages at least one of the upper clamp plate and the lower clamp plate.

6. The adjustable gate hinge of claim 4, wherein
the upper clamp plate and the lower clamp plate extend from a fastener plate, and
the clamping nut abuts the fastener plate.

7. The adjustable gate hinge of claim 1, wherein one or more of the clamp slot and the slide slot delimit rotation of the slider portion relative to the clamp.

8. The adjustable gate hinge of claim 1, wherein the clamp slot and the slide slot are diagonal relative to one another.

9. The adjustable gate hinge of claim 1, wherein
the clamp slot is a first clamp slot,
the slide slot is a first slide slot,
the fastener is a first fastener, and
the slider portion is adjustably connected to the clamp via a second fastener extending through a second clamp slot and a second slide slot.

10. The adjustable gate hinge of claim 9, wherein
the first clamp slot is orthogonal to the second clamp slot, and
the first slide slot is colinear with the second slide slot.

11. The adjustable gate hinge of claim 1, wherein the clamp is arcuate.

12. The adjustable gate hinge of claim 11, wherein the clamp defines a notch.

13. The adjustable gate hinge of claim 12, wherein the notch is at least partially serrated.

14. The adjustable gate hinge of claim 1, wherein a hinge pin extends through the slider portion.

15. The adjustable gate hinge of claim 1, wherein
the slider portion is an upper slider portion,
a lower slider portion defines a lower slide slot,
the fastener is a first fastener, and
the lower slider portion is adjustably connected to the clamp via a second fastener extending through the clamp slot and the lower slide slot.

16. An adjustable gate hinge kit comprising:
a post mount configured to removably mount to a post; and
a swing portion pivotably connected to the post mount and configured to removably mount to a gate, wherein
the post mount defines a pivot axis for the gate relative to the post and permits adjustment of the pivot axis relative to the post, and
the swing portion is configured to be non-rotatable relative to the gate.

17. The adjustable gate hinge kit of claim 16, wherein the post mount includes a slider portion translatably and rotatably connected to a clamping portion.

18. The adjustable gate hinge kit of claim 16, wherein the swing portion includes an anti-rotation buckle configured to prevent rotation of a pivot strap about an upright of the gate.

19. A swing portion of a hinge, the swing portion comprising:
a pivot strap configured to at least partially wrap around an upright of a gate;
an anti-rotation buckle configured to engage the pivot strap and at least partially wrap around a crossbar of the gate; and
a fastener extending through the pivot strap and the anti-rotation buckle.

20. The swing portion of claim 19, wherein the pivot strap extends between a first fastener lobe and a second fastener lobe of the anti-rotation buckle.
